(19) United States
(12) Patent Application Publication
(10) Pub. No.: US 2024/0250422 A1
(43) Pub. Date: Jul. 25, 2024

(54) ANTENNA SYSTEM AND PHASE CONTROL OF EMITTED AND REFLECTED SIGNALS

(71) Applicant: University of Massachusetts, Boston, MA (US)

(72) Inventors: Hualiang Zhang, Arlington, MA (US); Hong Tang, Lowell, MA (US); Bowen Zheng, Dracut, MA (US)

(21) Appl. No.: 18/563,684

(22) PCT Filed: Jun. 16, 2022
(86) PCT No.: PCT/US22/33857

§ 371 Date: Nov. 22, 2023

Related U.S. Application Data
(60) Provisional application No. 63/212,837, filed on Jun. 21, 2021.

(51) Int. Cl. H01Q 3/32; H01Q 1/48; H01Q 1/50

(52) U.S. Cl. CPC H01Q 3/32; H01Q 1/48; H01Q 1/50

(57) ABSTRACT

A circuit path (115) conveys energy from a feed source (120) to an antenna element (110). An intermediate structure (125) is disposed in the circuit path (115) between the feed source (120) and the antenna element (110). The intermediate structure (125) modifies a phase of first wireless signals (191) such as signals emitted in a first direction from the antenna element (110) towards the feed source (120). The intermediate structure (125) may modify a phase of a reflection of the first wireless signals emitted in a second direction toward the antenna, the second direction opposite the first direction. Modifying the phase of the emitted and reflected wireless signal provides an overall stronger output signal from the antenna. For example, the phase modified reflected wireless signal combines with an original transmitted wireless signal from the antenna to produce a strong output signal with across a wide bandwidth.

### RELATED APPLICATIONS

This application is a national stage filing of PCT application No.: PCT/US2022/033857 filed Jun. 16, 2022 (also known as Docket No. UML2021-15-02PCT), entitled ANTENNA SYSTEM AND PHASE CONTROL OF EMITTED AND REFLECTED SIGNALS, the entire teachings of which are incorporated herein by reference.

PCT application No.: PCT/US2022/033857 claims priority to earlier filed U.S. Patent Application Ser. No. 63/212,837 entitled “ANTENNA SYSTEM AND PHASE CONTROL OF EMITTED AND REFLECTED SIGNALS,” Attorney Docket No. UML2021-15-01, filed on Jun. 21, 2021, the entire teachings of which are incorporated herein by this reference.

### BACKGROUND

With the vastly developed market for high-resolution and long-range RF (Radio Frequency) systems for communication, sensing and imaging applications, the critical limitations are the antenna array's bandwidth and efficiency. The traditional approach to generating RF signals is based on the tightly coupled dipole arrays (TCDAs). Nevertheless, the arrays suffer from the reflection induced by the ground plane, and the operating bandwidth of these arrays is limited, resulting in a short detection range and low resolution. Another method can expand the bandwidth of the traditional TCDAs by adopting the lossy materials (e.g., resistive sheets). Nonetheless, the lossy materials will decrease the efficiency of the systems, leading to severe thermal problems.

### BRIEF DESCRIPTION OF EMBODIMENTS

This disclosure introduces a new way to address the aforementioned issues. Based on a lossless phase-modulated intermediate structure as discussed herein, a new TCDA provides broad bandwidth radiation capability and high radiation efficiency. The lossless structure as discussed herein can increase the operating bandwidth of an antenna and/or antenna array by modifying the phase rather than the magnitude of the reflection so that efficiency is not sacrificed. The operating bandwidth of the new TCDA as discussed herein is significantly increased compared with the traditional TCDAs. Furthermore, the efficiency is much higher than wireless radiation devices implementing lossy-material-based arrays.

More specifically, an antenna assembly includes a circuit path that conveys energy from a feed source to a respective antenna of the antenna assembly. An intermediate structure is disposed in the circuit path between the feed source and the respective antenna. The intermediate structure modifies a phase of first wireless signals such as signals emitted in a first direction (such as downward) from the antenna towards a ground plane associated with the feed source. The intermediate structure also can be configured to modify a phase of a reflection of the first wireless signals emitted in a second direction toward the antenna, the second direction opposite the first direction. As discussed herein, modifying the phase of the emitted wireless signals (those first wireless signals passing through the intermediate structure) as well as modifying the phase of the reflected wireless signals (reflection of the phase shifted first wireless signals) provides an overall stronger output signal from the antenna. For example, the phase modified reflected wireless signals combined with an original transmitted wireless signal from the antenna produce a stronger output signal across a wide bandwidth of producing the wireless signals.

Thus, the intermediate structure can be configured to modify the respective phase of the first wireless signals two times (such as one or more times).

In further example embodiments, the circuit path may pass through the intermediate structure. The circuit path may also include multiple conductive paths such as a first conductive path operative to convey the energy from the feed source to the antenna and a second conductive path operative to provide a ground reference (such as based on ground plane) to the intermediate structure and the antenna. In one embodiment, the circuit path is configured as a transmission line. One or more of the first conductive path and/or the second conductive path can be configured to taper along at least a portion of its respective length from the feed source to the antenna.

Yet further, the circuit path as discussed herein can be configured to extend through an opening of the intermediate structure.

Further examples herein include fabrication of the intermediate structure to include a patch of metal material. The patch can be coupled to a ground reference (such as ground plane) provided by the circuit path from the feed source. In one embodiment, the intermediate structure does not substantially attenuate or minimally attenuates the first wireless signals as the first wireless signals pass through the intermediate structure. For example, the intermediate structure includes at least one component thereon fabricated from metal, the at least one component operative to modify the phase of the first wireless signals passing through the intermediate structure. The intermediate structure can be configured to include a non-electrically conductive substrate (such as insulation material) on which the at least one phase shifting component is fabricated.

The intermediate structure potentially includes a first opening through which the circuit path passes. As previously discussed, the circuit path can be configured to extend between the feed source and the antenna. The intermediate structure can be configured to include a second opening to receive a ground reference from the antenna element.

In still further example embodiments, the first wireless signals emitted from the antenna pass through the intermediate structure and are reflected from a surface (such as a ground plane associated with the antenna element) back through the intermediate structure as third wireless signals. The intermediate modifies a phase of the third wireless signals. In addition to generating first wireless signals, the antenna outputs second wireless signals in a direction substantially opposite a travel direction of the first wireless signals. The combination of the third wireless signals and the second wireless signals results in an overall stronger signal transmitted from the antenna element.

Note that multiple instances of the antenna element as discussed herein can be implemented in an antenna array to create a chain of antennas supporting beamforming. Yet further techniques as discussed herein fabricating the antenna element as discussed herein.

As discussed herein, techniques herein are well suited to more efficiently generate wireless signals. However, it should be noted that embodiments herein are not limited to use in such applications and that the techniques discussed herein are well suited for other applications as well.

Note that any of the resources as discussed herein can include one or more computerized devices, fabrication equipment, sensors, servers, communication systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One embodiment includes a computer readable storage medium and/or system having instructions stored thereon. The instructions, when executed by the computer processor hardware, cause the computer processor hardware (such as one or more co-located or disparately processor devices or hardware and fabrication equipment) to: fabricate an antenna element to include: i) an antenna; ii) a circuit path operative to convey energy from a feed source to the antenna element; and iii) an intermediate structure disposed in the path between the feed source and the antenna element, the intermediate structure operative to modify a phase of first wireless signals emitted in a first direction from the antenna element towards the feed source.

The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing improved wireless connectivity in a network environment. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating a unit cell (a.k.a., antenna assembly) of an antenna array system according to embodiments herein.

FIG. 2 is an example diagram illustrating of a circuit path such as a transmission line according to embodiments herein.

FIG. 3 is an example diagram illustrating an antenna according to embodiments herein.

FIG. 4 is an example diagram illustrating an intermediate structure to provide phase shifting of original and reflected wireless signals according to embodiments herein.

FIG. 5 is an example diagram illustrating implementation of a unit cell and corresponding dimensions associated with an antenna assembly according to embodiments herein.

FIG. 6A and FIG. 6B are example diagrams illustrating Voltage Standing Wave Ratio (VSWR) versus frequency and Radiation Efficiency versus frequency according to embodiments herein.

FIG. 7A and FIG. 7B are example diagrams illustrating Voltage Standing Wave Ratio (VSWR) versus frequency and Radiation Efficiency versus frequency based on implementing a shorting sheet according to embodiments herein.

FIG. 8 is an example diagram illustrating phase shifting of wireless signals via implementation of an intermediate structure of the antenna assembly according to embodiments herein.

FIG. 9 is an example diagram illustrating implementation of an intermediate structure to provide phase shifting of signals according to embodiments herein.

FIG. 10 is an example diagram illustrating implementation of an intermediate structure to provide phase shifting of signals according to embodiments herein.

FIG. 11 is an example diagram illustrating an antenna array including multiple instances of antenna elements (antenna assemblies) to provide beamforming according to embodiments herein.

FIG. 12 is an example diagram illustrating example computer hardware and software operable to execute one or more fabrication operations according to embodiments herein.

FIG. 13 is an example diagram illustrating a method of fabricating an antenna assembly according to embodiments herein.

FIG. 14 is an example diagram illustrating a method of an antenna assembly implementing phase control according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### FURTHER DESCRIPTION OF EMBODIMENTS

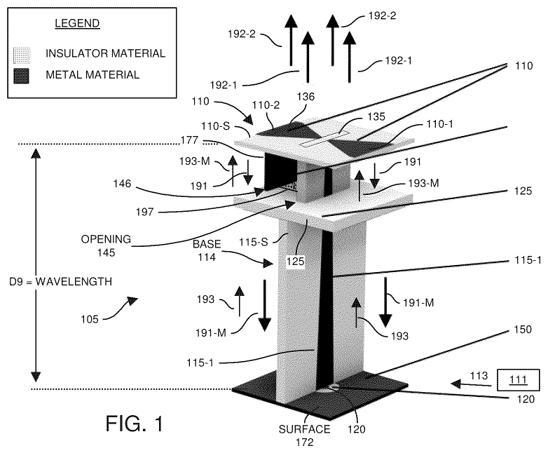

FIG. 1 is an example diagram illustrating of a unit cell of an antenna array system according to embodiments herein.

As shown in FIG. 1, a unit cell or antenna assembly 105 (apparatus) includes an antenna 110 (antenna element 110-1 and antenna element 110-2 disposed on substrate 110-S) and a circuit path 115 that conveys energy from a feed source 120 to the antenna element 110. The unit cell of the antenna assembly 105 further includes an intermediate structure 125 disposed in the circuit path 115 between the feed source 120 (feed in a ground plane 150 or ground plane substrate through which signal 113 is input to the conductive path 115-1 via an opening in the ground plane) and the antenna element 110.

In one embodiment, the antenna is a dipole antenna or other suitable type of antenna.

The signal generator 111 applies (inputs) a respective electrical signal 113 (having a frequency, F) to the feed source 120 (a.k.a., feeding port opening of the ground plane 150). The conductive path 115 conveys the corresponding energy associated with the signal 113 (a.k.a., signal S1 as further discussed herein) to the antenna element 110. In response to receiving the signal 113 (and ground on conductive path 115-2), the antenna element 110 radiates wireless signals 192-1 (upward) and wireless signals 191 (downward).

The signal generator can be configured to control the frequency of the signal 113 to be between 1 to 8 Ghz or other suitable value or range.

In further example embodiments, as shown, the substrate 110-S of antenna 110 is spaced apart with respect to the ground plane 150 and/or surface 172 by a distance D9=WL, where the wavelength WL=1/F. As previously discussed, the value F is the frequency of the signal 113 and wireless signals 192-1 and 191. Each of the wireless signals 191 and 192-1 has a wavelength of 1/F.

As further discussed herein, the wireless signals 191 pass through the novel intermediate structure 125 and are phase shifted. More specifically, the intermediate structure 125 phase shifts wireless signals 191 to produce phase shifted wireless signals 191-M directed to the ground plane 150. The wireless signals 191-M reflect off ground plane 150 (surface 172) as wireless signals 193. The wireless signals 193 pass through the intermediate structure 125 and are phase shifted. For example, the intermediate structure 125 phase shifts wireless signals 193 to produce phase shifted wireless signals 193-M. Wireless signals 193-M pass through the antenna substrate 110-S as wireless signals 192-2 (with no phase change) to at least partially constructively combine with the wireless signals 192-1 emitted upwards from the antenna 110. Thus, rather than absorbing the wireless signals 191 in a lossy material, the wireless signals 191 are advantageously used to produce wireless signals 192-2 resulting in an increase an amplitude of signals (191-1 plus 192-2) emitted in an upward direction from the antenna assembly 105.

In further example embodiments, the circuit path 115 such as a transmission line includes a first conductive path 115-1 on one facing of substrate 115-S; the first conductive path conveys the energy associated with signal 113 from the feed source 120 to the antenna element 110-1; the circuit path 115 also includes a second conductive path 115-2 on another facing of substrate 115-S that provides a ground reference 150 to the intermediate structure 125. The antenna 110-1 converts the received signal 113 into wireless signals 191 and wireless signals 192-1.

Note that the first conductive path 115-1 also tapers along at least a portion of its length from the feed source 120 through the intermediate structure 125 to the antenna element 110. The second conductive path 115-2 (as discussed in further drawings also tapers along at least a portion of its length from the feed source 120 through the intermediate structure 125 to the antenna element 110.

In one embodiment, the circuit substrate 115-S and corresponding conductive paths 115 extends through an opening 145 of the intermediate structure 125.

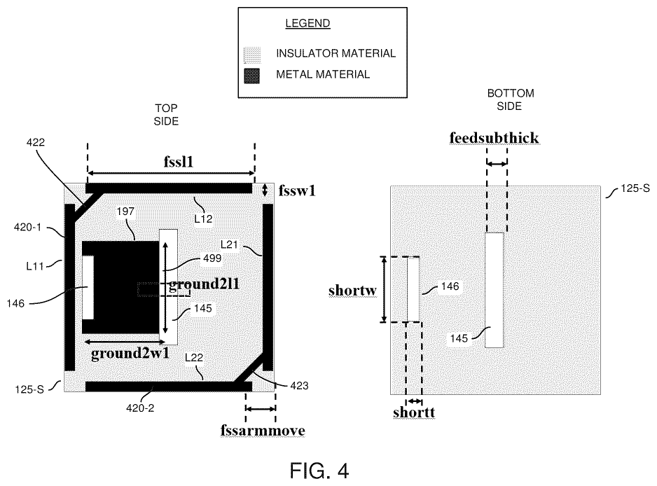

In still further embodiments, the intermediate structure 125 further includes one or more patch elements 197 fabricated from metal material (see different examples in FIGS. 4, 7, and 8) to provide common mode control associated with the antenna assembly 105. As further shown, the so-called shorting sheeting 177 (metal layer or circuit path parallel to substrate 115-S) also provides common mode control associated with the antenna assembly 105. The patch 197 (disposed on substrate 125-S of the intermediate structure 125) is coupled to a ground reference 150 provided through the circuit path 115-2 and shorting sheet 197.

During operation, the intermediate structure 125 does not substantially attenuate the first wireless signals 191 although the intermediate structure 125 and corresponding patch element 197 does provide phase shifting of wireless signals. As previously discussed, in one embodiment, the first wireless signals 191 are signals emitted from the antenna element 110 toward the intermediate structure 125. The intermediate structure 125 provides phase shifting of the wireless signals 191 into wireless signals 191-M. The wireless signals 191-M reflect off of the ground plane 150 as wireless signals 193. The intermediate structure 125 phase shifts the wireless signals 193 to produce wireless signals 193-M. The wireless signals 193-M pass through the antenna 110 as wireless signals 192-2.

Based on signal 113 applied to the antenna 110, the antenna element 110 also outputs second wireless signals 192-1 in a direction substantially opposite from the first wireless signals 191. If desired, a superstrate material is disposed over the antenna substrate 110-S. The wireless signals 192-1 and 192-2 combine to produce an output from the antenna assembly 105.

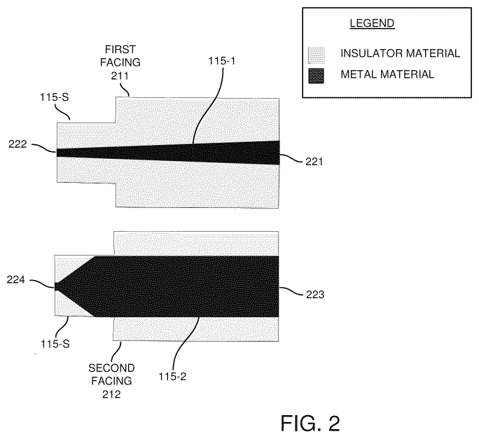

FIG. 2 is an example diagram illustrating of a path such as a transmission line according to embodiments herein.

As shown, the first facing 211 of the substrate 115-S (fabricated from insulator material) includes the conductive path 115-1 (fabricated from any suitable electrically conductive material, metal material, etc.) which tapers from the right to the left. As previously discussed, the conductive path 115-1 carries the signal 113. Node 221 (located near the signal feed) is configured to receive the signal 113 generated by the signal generator 111. At an opposite end, the node 222 is coupled to the antenna element 110-1.

The second facing 212 of the substrate 115-S (fabricated from insulator material) includes the conductive path 115-2 (fabricated from any suitable electrically conductive material, metal material, etc.) which includes a respective taper. As previously discussed, the conductive path 115-2 provides connectivity of the antenna element 110-2 to the ground plane 150 disposed on the surface 172. More specifically, node 223 of the second circuit path 115-2 is connected to the ground plane 150. At an opposite end, the node 224 is coupled to the antenna element 110-2.

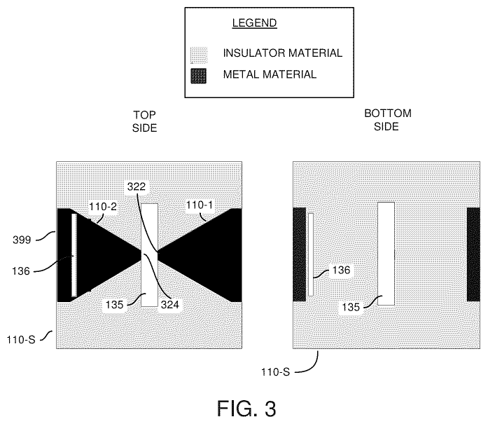

FIG. 3 is an example diagram illustrating an antenna according to embodiments herein.

As previously discussed, the top side of antenna substrate 110-S includes antenna element 110-1 as well as antenna element 110-2. Additionally, the antenna substrate 110-S includes opening 135 as well as opening 136.

The axial end of the substrate 115-S extends through and to the top side of antenna substrate 110-S. The node 222 of the circuit path 115-1 is electrically coupled to the node 322 of the antenna element 110-1. The node 224 of the circuit path 115-2 is electrically coupled to the node 324 of the antenna element 110-2.

FIG. 4 is an example diagram illustrating an intermediate structure to provide phase shifting of signals according to embodiments herein.

In further example embodiments, in addition to including patch element 197 disposed on the substrate of intermediate structure 125, the intermediate structure 125 includes at least one circuit component 420-1 (layer of material such as including first leg L11 and second leg L12 connected via arm 422) and circuit component 420-2 (layer of material such as first leg L21 and second leg L22 connected via arm 423) thereon. The one or more components such as layers of material are fabricated from metal (i.e., electrically conductive material). The intermediate structure 125 includes a non-electrically conductive substrate 125-S on which the one or more components 420-1, 420-2 are fabricated. As previously discussed in FIG. 1, the received wireless signals 191 are phase adjusted via the intermediate structure 125 into wireless signals 191-M. The received wireless signals 193 are phase adjusted via the intermediate structure 125 into wireless signals 193-M.

Note further that the so-called shorting sheet 177 of electrically conductive material electrically couples the axial end node 399 (FIG. 3) antenna element 110-2 to the patch element 197 near opening 146. Patch element 197 connects the shorting sheet 177 received through opening 146 to the conductive path 115-2 at node 499 of the shorting sheet near opening 145.

Referring again to FIG. 1, as previously discussed, the first wireless signals 191 passing through the intermediate structure 125 as wireless signals 191-M are reflected from a surface 172 back through the intermediate structure 125 as third wireless signals 193. The intermediate structure 125 modifies a phase of the third wireless signals 193 reflected off surface 172 to produce phase adjusted wireless signals 193-M.

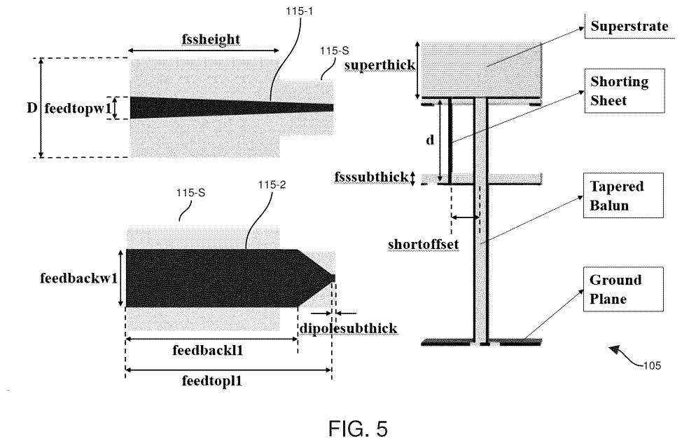

FIG. 5 is an example diagram illustrating implementation of a unit cell and corresponding dimensions associated with an antenna assembly according to embodiments herein.

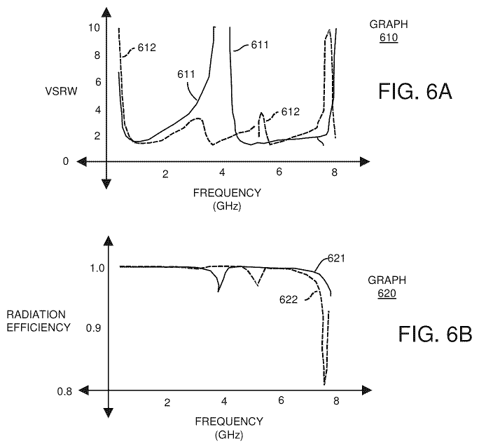

FIG. 6A is an example diagram illustrating Voltage Standing Wave Ratio (VSWR) versus frequency and Radiation Efficiency versus frequency according to embodiments herein.

Line 611 in graph 610 illustrates a hypothetical VSRW versus frequency for a conventional wireless device that does not include the intermediate structure 125. Line 612 in graph 610 illustrates a hypothetical VSRW versus frequency for the antenna assembly 105 including the intermediate structure 125 as discussed herein.

FIG. 6B is an example diagram illustrating Radiation Efficiency versus frequency according to embodiments herein.

Line 621 in graph 620 illustrates a hypothetical wireless radiation efficiency versus frequency for a conventional wireless device that does not include the intermediate structure 125. Line 622 in graph 620 illustrates a hypothetical wireless radiation efficiency versus frequency for the antenna assembly 105 including the intermediate structure 125 as discussed herein.

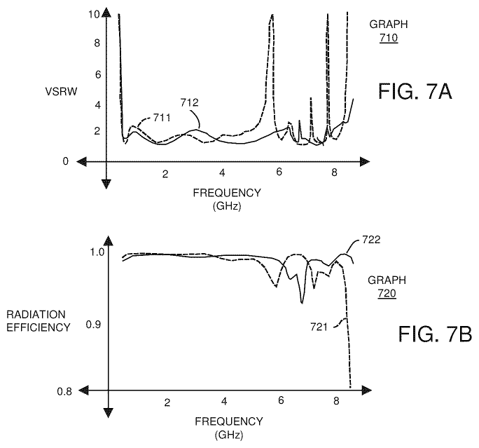

FIG. 7A is an example diagram illustrating Voltage Standing Wave Ratio (VSWR) versus frequency and Radiation Efficiency versus frequency according to embodiments herein.

The common mode implemented by the tapered balun (conductive path 115-2) as discussed herein cuts the operating frequency at higher frequencies. Implementation of the shorting sheet 177 via implementation of the intermediate structure 125 shifts the cut-off frequency out of the operating frequency band.

Line 711 in graph 710 illustrates a hypothetical VSRW versus frequency for a conventional wireless device that does not include the intermediate structure 125 and implementation of the conductive path 115-2. Line 712 in graph 710 illustrates a hypothetical VSRW versus frequency for the antenna assembly 105 including the intermediate structure 125 (conductive path 115-2 and shorting sheet 177) as discussed herein.

FIG. 7B is an example diagram illustrating Radiation Efficiency versus frequency according to embodiments herein.

Line 721 in graph 720 illustrates a hypothetical wireless radiation efficiency versus frequency for a conventional wireless device that does not include the intermediate structure 125. Line 722 in graph 720 illustrates a hypothetical wireless radiation efficiency versus frequency for the antenna assembly 105 including the intermediate structure 125 (conductive path 115-2 and shorting sheet 177) as discussed herein.

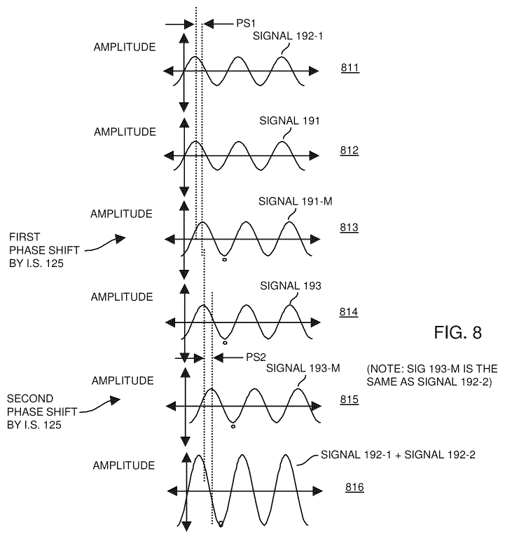

FIG. 8 is an example diagram illustrating phase shifting of wireless signals by an intermediate structure of the antenna assembly according to embodiments herein.

As previously discussed, the signal generator generates signal 113 applied to the antenna assembly 105.

Graph 811 illustrates attributes (amplitude and phase over time) of the wireless signals 192-1 transmitted upward from the antenna 110.

Graph 812 illustrates attributes (amplitude and phase over time) of the wireless signals 191 transmitted from the antenna 110.

Graph 813 illustrates attributes (amplitude and phase over time) of the wireless signals 191-M generated via phase shifting (by phase shift amount PS1) of the wireless signals 191.

Graph 814 illustrates attributes (amplitude and phase over time) of the wireless signals 193 reflecting off surface 172 (ground plane 150).

Graph 815 illustrates attributes (amplitude and phase over time) of the wireless signals 193-M generated via phase shifting (by phase shift amount PS2) of the wireless signals 193.

Graph 816 illustrates a combination of wireless signal 192-1 and wireless signals 192-2 (constructive, adding, output combination of signals), where wireless signals 192-2 represents wireless signals 193-M passing through the antenna substrate 110-S. Wireless signals 192-1 are phased shifted with respect to wireless signals 191 by an amount PS1+PS2.

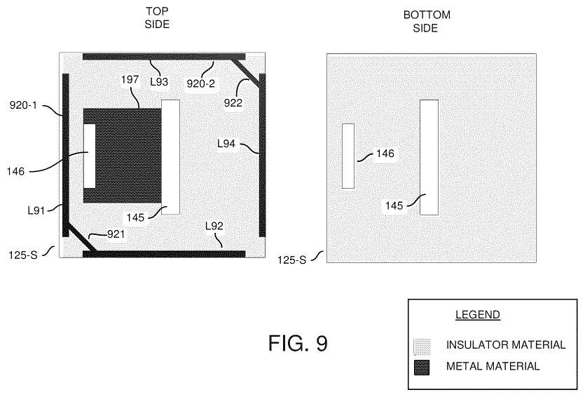

FIG. 9 is an example diagram illustrating implementation of an intermediate structure to provide phase shifting of signals according to embodiments herein.

In further example embodiments, in addition to including patch element 197 disposed on the substrate of intermediate structure 125, the intermediate structure 125 includes at least one circuit component 920-1 (layer of material such as first leg L91 and second leg L92 connected via arm 922) and circuit component 920-2 (layer of material such as first leg L93 and second leg L94 connected via arm 922) thereon. The one or more components such as layers of material are fabricated from metal (i.e., electrically conductive material). The intermediate structure 125 includes a non-electrically conductive substrate on which the one or more components 920-1, 920-2, and patch element 197 are fabricated.

Note further that the so-called shorting sheet 177 of electrically conductive material electrically couples the antenna element 110-2 to the patch element 197 near opening 146. Patch element 197 connects the shorting sheet 177 to the conductive path 115-2 near opening 145 in a similar manner as previously discussed. Thus, a conductive path loop is formed via connectivity of the antenna element 110-2, shorting sheet 177, patch element 197, and a portion of the conductive path 115-2.

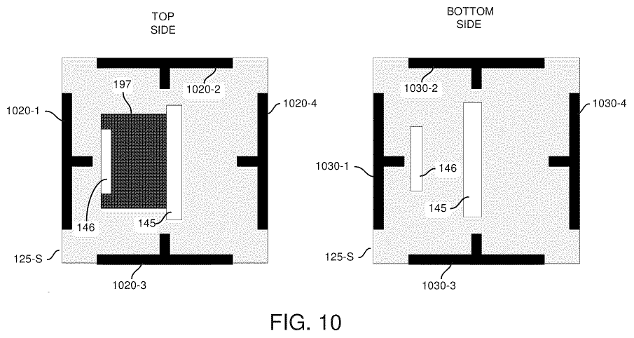

FIG. 10 is an example diagram illustrating implementation of an intermediate structure to provide phase shifting of signals according to embodiments herein.

In this example embodiment, the intermediate structure 125 and corresponding substrate 125-S include multiple T-structures 1020-1, 1020-2, 1020-3, and 1020-4 disposed on respective four edges of a top side of the substrate 125-S. The intermediate structure 125 and corresponding substrate 125-S include multiple T-structures 1030-1, 1030-2, 1030-3, and 1030-4 disposed on respective four edges of a top side of the substrate 125-S.

In a similar manner as previously discussed, the intermediate structure 125 provides phase shifting of the respective wireless signals passing through from one side of the intermediate structure to the other.

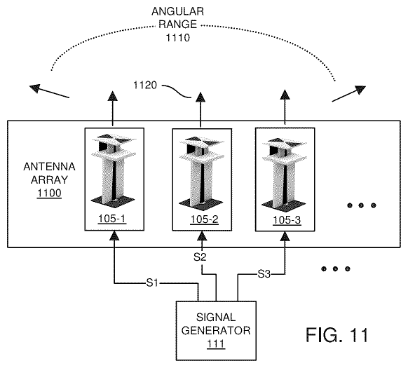

FIG. 11 is an example diagram illustrating an antenna array including multiple instances of antenna elements (assemblies) according to embodiments herein.

This example embodiment includes multiple instances of antenna assemblies disposed in antenna array 1100. Signal generator 111 generates drive signals S1 (a.k.a., signal 113), S2, S3, etc. For example, the signal generator 111 applies signal S1 to the feed source of the first instance of the antenna assembly 105-1; the signal generator 111 applies signal S2 to the feed source of the second instance of the antenna assembly 105-2; the signal generator 111 applies signal S3 to the feed source of the third instance of the antenna assembly 105-3; and so on.

The respective ground plane of each antenna assembly is connected to each other. The signal generator 111 can be configured to adjust phases of the signals S1, S2, S3, etc., to steer the respective output wireless signals 1120 within angular range 1110.

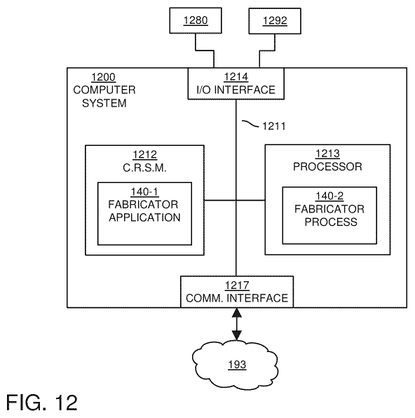

FIG. 12 is an example block diagram of a computer system for implementing any of the operations as previously discussed according to embodiments herein.

Note that any of the resources (such as mobile communication devices, user equipment, wireless stations, wireless base stations, communication management resource, control management resource, etc.) as discussed herein can be configured to include computer processor hardware and/or corresponding executable instructions to carry out the different operations as discussed herein.

For example, as shown, computer system 1250 of the present example includes interconnect 1211 coupling computer readable storage media 1212 such as a non-transitory type of media (which can be any suitable type of hardware storage medium in which digital information can be stored and or retrieved), a processor 1213 (computer processor hardware), I/O interface 1214, and a communications interface 1217.

I/O interface(s) 1214 supports connectivity to repository 1280 and input resource 1292.

Computer readable storage medium 1212 can be any hardware storage device such as memory, optical storage, hard drive, floppy disk, etc. In one embodiment, the computer readable storage medium 1212 stores instructions and/or data.

As shown, computer readable storage media 1212 can be encoded with fabrication application 140-1 (e.g., including instructions) in a respective wireless station to carry out any of the operations as discussed herein.

During operation of one embodiment, processor 1213 accesses computer readable storage media 1212 via the use of interconnect 1211 in order to launch, run, execute, interpret or otherwise perform the instructions in fabrication application 140-1 stored on computer readable storage medium 1212. Execution of the fabrication application 140-1 produces fabrication process 140-2 to carry out any of the operations and/or processes as discussed herein.

Those skilled in the art will understand that the computer system 1250 can include other processes and/or software and hardware components, such as an operating system that controls allocation and use of hardware resources to execute the fabrication application 140-1.

In accordance with different embodiments, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1250 may reside at any location or can be included in any suitable resource in any network environment to implement functionality as discussed herein.

Functionality supported by the different resources will now be discussed via the flowchart in FIG. 12. Note that the steps in the flowcharts below can be executed in any suitable order.

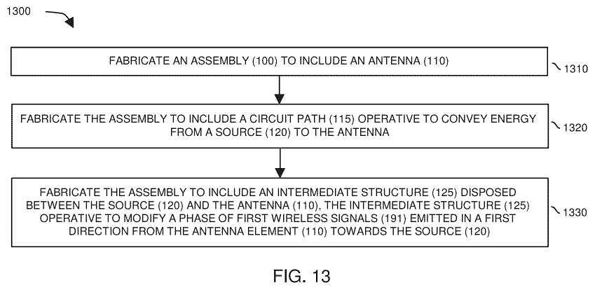

FIG. 13 is a flowchart 1300 illustrating an example method according to embodiments herein. Note that there will be some overlap with respect to concepts as discussed above.

In processing operation 1310, the fabricator 140 fabricates an assembly 105 to include an antenna 110.

In processing operation 1320, the fabricator 140 fabricates the assembly 105 to include a circuit path 115 operative to convey energy from a source 120 to the antenna 110.

In processing operation 1330, the fabricator 140 fabricates the assembly 105 to include an intermediate structure 125 disposed between the feed source 120 and the antenna 110; the intermediate structure 125 is operative to modify a phase of first wireless signals 191 emitted in a first direction from the antenna element 110 towards the source 120 (i.e., feed port) from which the antenna element receives a feed signal (drive signal 113, S1, S2, S3, etc.).

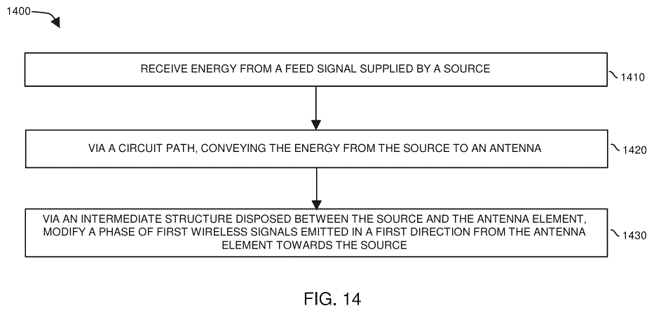

FIG. 14 is a flowchart 1400 illustrating an example method according to embodiments herein. Note that there will be some overlap with respect to concepts as discussed above.

In processing operation 1410, the antenna assembly 105 receives energy from a feed signal 113 (a.k.a. signal S1) supplied by a source 120 (feed).

In processing operation 1420, via a circuit path 115, the antenna assembly 105 conveys the energy from the source 120 to an antenna 110.

In processing operation 1430, via an intermediate structure 125 disposed between the source 120 and the antenna element 110, the antenna assembly 105 modifies a phase of first wireless signals 191 emitted in a first direction from the antenna element 110 towards the source 120 (surface 172).

Note again that techniques as discussed herein are well suited for use in antenna applications. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

1. An antenna element comprising:
an antenna;
a circuit path operative to convey energy from a feed source to the antenna; and
an intermediate structure disposed between the feed source and the antenna, the intermediate structure operative to modify a phase of first wireless signals emitted in a first direction from the antenna element towards a ground plane associated with the feed source 120.

2. The antenna element as in claim 1, wherein the first wireless signals pass through the intermediate structure; and
wherein the intermediate structure is further operative to receive and modify a phase of reflected signals, the reflected signals being the phase modified first wireless signals reflected off a surface, the reflected signals traveling in a second direction, the second direction being opposite the first direction.

3. The antenna element as in claim 1, wherein the circuit path passes through the intermediate structure;
wherein the circuit path includes a first conductive path operative to convey the energy from the feed source to the antenna; and
wherein the circuit path includes a second conductive path operative to provide a ground reference to the intermediate structure and the antenna.

4. The antenna element as in claim 3, wherein the circuit path is a transmission line.

5. The antenna element as in claim 4, wherein the first conductive path tapers along at least a portion of its length from the feed source to the antenna.

6. The antenna element as in claim 1, wherein the circuit path extends through an opening of the intermediate structure.

7. The antenna element as in claim 1, wherein the intermediate structure includes a patch fabricated from metal material.

8. The antenna element as in claim 7, wherein the patch is coupled to a ground reference provided by the circuit path.

9. The antenna element as in claim 1, wherein the intermediate structure does not substantially attenuate the first wireless signals as the first wireless signals pass through the intermediate structure 125.

10. The antenna element as in claim 1, wherein the first wireless signals passing through the intermediate structure are reflected from a surface back through the intermediate structure as third wireless signals, the intermediate structure operative to modify a phase of the third wireless signals.

11. The antenna element as in claim 10, wherein the antenna outputs second wireless signals in a direction substantially opposite a travel direction of the first wireless signals.

12. The antenna element as in claim 1, wherein the intermediate structure includes at least one component thereon fabricated from metal, the at least one component operative to modify the phase of the first wireless signals.

13. The antenna element as in claim 12, wherein the intermediate structure includes a non-electrically conductive substrate on which the at least one component is fabricated.

14. The antenna element as in claim 1, wherein the intermediate structure includes a first opening through which the circuit path passes, the circuit path extending between the feed source and the antenna; and
wherein the intermediate structure includes a second opening to receive a ground reference from the antenna element.

15. A system comprising:
multiple instances of the antenna element of claim 1 disposed in an antenna array.

16. A method comprising:
fabricating the antenna element of claim 1.

17. A method comprising:
receiving energy from a feed signal supplied by a feed source;
via a circuit path, conveying the energy from the feed source to an antenna; and
via an intermediate structure disposed between the feed source and the antenna element, modifying a phase of first wireless signals emitted in a first direction from the antenna element towards a ground plane associated with the feed source.

18. The method as in claim 17, wherein the first wireless signals pass through the intermediate structure; and
via the intermediate structure, receiving and modifying a phase of reflected signals, the reflected signals being the phase modified first wireless signals reflected off a surface, the reflected signals traveling in a second direction, the second direction being opposite the first direction.

19. The method as in claim 17, wherein the circuit path passes through the intermediate structure, the method further comprising:
conveying the energy from the feed source to the antenna via a first conductive path of the circuit path; and
providing a ground reference to the intermediate structure and the antenna via a second conductive path the circuit path.

20. The method as in claim 19, wherein the circuit path is a transmission line.

21-27. (canceled)
